(19) United States
(12) Patent Application Publication
(10) Pub. No.: US 2023/0359878 A1
(43) Pub. Date: Nov. 9, 2023

(54) Analog Neural Network and Method for Advanced Process Node Integration

(71) Applicant: David Joseph Anderson, Scottsdale, AZ (US)

(72) Inventor: David Joseph Anderson, Scottsdale, AZ (US)

(21) Appl. No.: 18/313,036

(22) Filed: May 5, 2023

Related U.S. Application Data
(60) Provisional application No. 63/338,782, filed on May 5, 2022.

(51) Int. Cl. G06N 3/065; G06N 3/049

(52) U.S. Cl. CPC G06N 3/065; G06N 3/049

(57) ABSTRACT

A neural network has a synapse module with a plurality of synapses. A steering circuit is coupled to an output of the synapse module. A plurality of processing elements is coupled to an output of the steering circuit. Each of the processing elements share the synapses of the synapse module through the steering circuit. A first processing element of the plurality of processing elements receives a first current from a first output of the first synapse and a second current from a second output of the first synapse through the steering circuit. The first processing element has a first capacitor receiving the first current, and a second capacitor receiving the second current to generate a pulse width modulate output signal of the first processing element. A polarity inversion circuit is coupled for receiving the first current and reversing flow direction of the first current.

### CLAIM OF DOMESTIC PRIORITY

The present application claims the benefit of Provisional Application No. 63/338,782, filed May 5, 2022, which application is incorporated herein by reference.

### FIELD OF THE INVENTION

The present invention relates in general to neural networks, and more particularly, to an analog neural network and method for advanced process node integration.

### BACKGROUND

A biological neuron is a single nervous cell responsive to stimuli through weighted inputs known as synapses. One neuron can have many synapses. The weighted stimuli are summed and processed through a particular non-linearity associated with the neuron for providing an output signal. The output of the neuron may then be connected to one or more synapses of the next level neuron forming an interconnection of neurons known as a neural network, the latter of which possesses certain desirable properties including the ability to learn and recognize information patterns in a parallel manner. Neural networks can form the basis of artificial intelligence (AI).

Technologists have long studied the advantageous nature of the biological neuron in an attempt to emulate its behavior with electrical circuits. Modern electrical circuits have achieved some degree of success in emulating the biological neuron.

FIG. 1 illustrates one such conventional analog circuit 50 emulating a neuron. Analog circuit 50 receives voltages V_{NEG1} at input terminal 52, V_{NEG2} at input terminal 54, V_{NEGN} at input terminal 56, V_{POS1} at input terminal 58, V_{POS2} at input terminal 60, and V_{POSM} at input terminal 62, where M and N are any integer. Analog device 50 can have any number of input terminals. Circuit element 70 is coupled between input terminal 52 and node 72. In one embodiment, circuit element 70 is a resistor. Circuit element 70 converts V_{NEG1} to current I_{NEG1} flowing into node 72. In a similar manner, circuit elements 74 and 76 convert V_{NEG2} and V_{NEGN} into currents I_{NEG2} and I_{NEGN} flowing into node 72, respectively. Circuit element 78 is coupled between input terminal 58 and node 80. In one embodiment, circuit element 78 is a resistor. Circuit element 78 converts V_{POS1} to current I_{PSO1} flowing into node 80. In a similar manner, circuit elements 82 and 84 convert V_{POS2} and V_{POSM} into currents I_{POS2} and I_{POSM} flowing into node 80, respectively. Node 72 and node 80 represent positive and negative summing nodes.

Node 72 is coupled to the inverting input of amplifier 90, and node 80 is coupled to the non-inverting input of the amplifier. Circuit element 92 is coupled between the output of amplifier 90 at output terminal 98 and the inverting input of the amplifier. In one embodiment, circuit element 92 is a resistor. Circuit element 94 is coupled between node 80 and power supply conductor 96, operating at ground potential. In one embodiment, circuit element 94 is a resistor. Circuit element 94 converts the voltage at node 80 to current I₉₄.

In the configuration of FIG. 1, voltages are converted to currents and summed on the inverting and noninverting nodes 72 and 80 of amplifier 90 based on whether the weights are positive or negative. However, the configuration is valid with input signals represented by voltage levels, as there is no memory.

Other examples of electrical neural networks comprise resistor arrays, floating gates, and adaptive logic each of which possess one or more limitations. Yet, in practice, the functional benefit-to-physical size ratio remains small. Most neural networks would become physically too large to achieve a practical, let alone advanced, functionality.

As indicated, some of the advantages of the neural network include the learning and recognition of patterns and shapes. The neural network may be taught a particular pattern and later be called upon to identify the pattern from a distorted facsimile of the same pattern. Unlike conventional signal processing techniques where the solution is programmed with a predetermined algorithm, the recognition technique of the neural network may be learned through an iterative process of adding random noise to the input signal of an ideal pattern, comparing the output signal of the neural network with the ideal pattern, and adjusting the synaptic weights to provide the correct response.

In a broader application, neural networks are considered key to the advancement of AI. An efficient inference remains a challenge in next generation AI even with the advancements in training algorithms and specialized hardware accelerators currently available. The energy demands of such hardware limit the applications of AI technologies in many real-world applications. The use of analog compute elements for machine learning and AI has been proposed for many years, but a viable approach that was flexible and powerful remains elusive. Further, advances in process nodes have advanced digital approaches while seeming to diminish the inherent advantages of analog computing, even without considering power usage. Yet for many mobile applications, power consumption becomes a critical limitation. Several approaches to mixed signal hardware implementations have been pursued through commercialization of these approaches. The problems of reconfigurability, power efficiency, and in situ adaptation through a pure analog implementation that can scale with technology nodes remains unsolved. There is a need to reduce the size or footprint of functional neural networks.

### BRIEF DESCRIPTION OF THE DRAWINGS

FIG. 1 illustrates a conventional analog neural network;

FIG. 2 illustrates an analog neural network with layers of neurons;

FIGS. 3a-3b illustrate an ANN with shared synapse module and current steering switch matrix;

FIG. 4 illustrates a synapse network with active memory devices;

FIG. 5 illustrates a waveform plot of the synapse network of FIG. 4;

FIGS. 6a-6b illustrate a capacitor network for the processing element operating with the synapse network;

FIG. 7 illustrates further detail of the processing element of the ANN;

FIG. 8 illustrates another synapse network with active memory devices and threshold circuit;

FIGS. 9a-9c illustrates various circuits to perform a polarity inversion of the output signal of the synapse network;

FIG. 10 illustrates a processing element using the polarity inversion circuit;

FIG. 11 illustrates a waveform plot of the activation feature of FIG. 10;

FIG. 12 illustrates another activation circuit to start a synapse processing cycle;

FIG. 13 illustrates a waveform plot of the activation circuit of FIG. 12;

FIG. 14 illustrates an ANN with a digital switch matrix;

FIG. 15 illustrates a waveform plot of error feedback;

FIG. 16 illustrates an ANN with an interlayer interconnect structure;

FIG. 17 illustrates internal current summations for error backpropagation in the forward and reverse paths of FIG. 16;

FIG. 18 illustrates an implementation of pulse generation; and

FIGS. 19a-19c illustrate a semiconductor wafer with a plurality of first semiconductor die separated by a saw street.

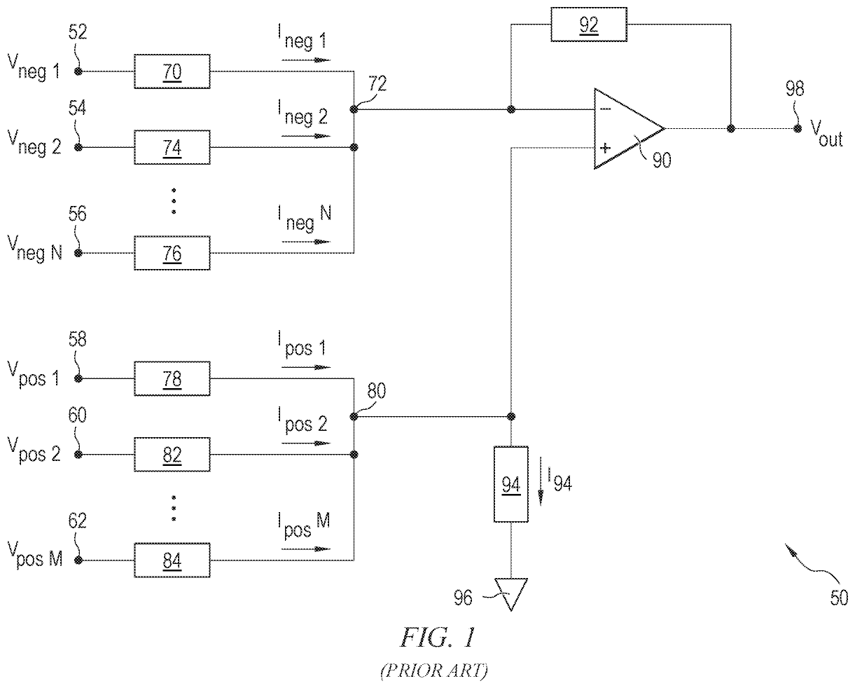

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

There are several elements necessary for implementing an analog neural network (ANN), which will be described herein. Further, illustrations of simplified and improved circuits are used to demonstrate the idea, but other implementations may be envisioned with functional equivalence.

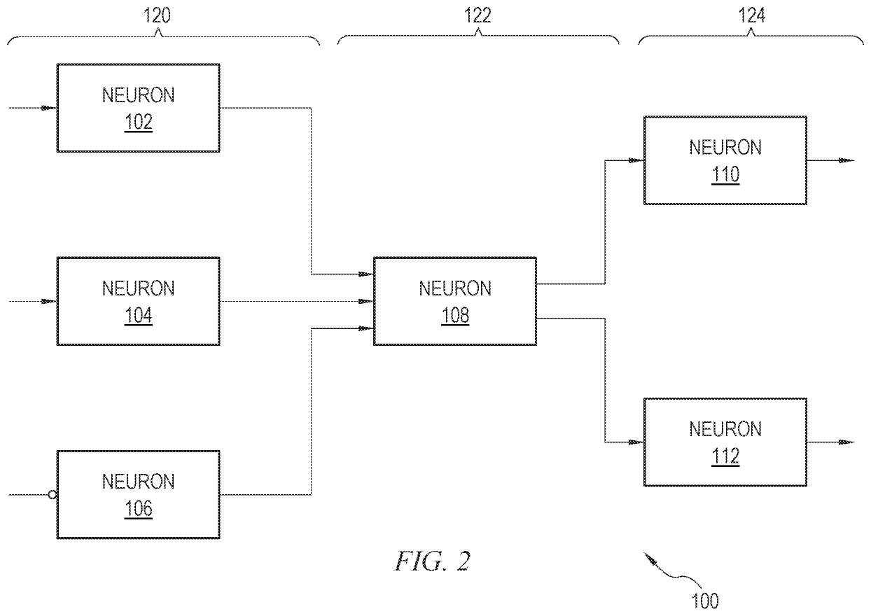

FIG. 2 represents a simplified ANN 100 with neuron 102, neuron 104, and neuron 106 each receiving an input signal from an external source or from a previous neuron. The outputs of neurons 102-106 are coupled to inputs of neuron 108, and the output of neuron 108 is coupled to inputs of neurons 110 and 112. The outputs of neurons 110 and 112 are coupled to an external terminal or the next level of neurons. Each neuron can have hundreds or thousands of inputs and its output can couple to hundreds or thousands of other neurons. Within ANN 100, one layer of neurons is coupled to another layer of neurons forming the network. Simplified ANN 100 is shown with three layers, i.e., neurons 102-106 as layer 120, neuron 108 as layer 122, and neurons 110 and 112 as layer 124. A practical ANN would have many more layers. Each of neurons 102-112 uses one or more synapses. The synapses are typically weighted to provide appropriate processing within the ANN as a whole.

The key part of analog compute is to utilize basic electrical relationships, such as V=I*R (voltage is current times resistance) as a single element multiplier, or current summing on a node as a summation function. In order to use the V=I*R relationship as a synaptic weight, some means of varying both I and R will be needed. These can be volatile or non-volatile although non-volatile is preferred if easily reprogrammable. Some implementations utilize a digital storage word and a digital-to-analog converter (DAC) to convert the digital word to an analog level. The digital to analog approach can be used in a non-volatile mode, as well as volatile memories. Preferred methods are a direct non-volatile analog storage device and three approaches are provided. The first approach is a memristor where the resistance is varied by programming pulses driven between the two terminals. The second approach is the use of floating gate memory where charge is trapped on the floating gate during a programming phase. The trapped charge alters the effective device threshold resulting in change in current for a fixed gate bias. The last type of analog memory works similar to the floating gate device, but without the high programming voltages. The charge trap memory (CTM) utilizes charge trapping in high K dielectric gate oxide as a means to vary the effective device threshold. The high K dielectrics are found in advanced semiconductor process nodes, although both floating gate, memristors, and DACs could be used with the same concepts.

What is needed for an optimal hardware configuration is a high ratio of signal-to-noise (S/N) relative to power consumption, while being compatible for modes of in-situ learning. The hardware should allow dense synaptic connections while being well controlled. Noise in analog systems is the result of both active and passive devices. Optimal performance is achieved by direct relationship between current and achieved S/N ratio. A design where all synaptic current directly increases S/N with minimal overhead is desired.

Another key element is the ability to store weights within a network. Volatile storage or one-time programmable elements may work, but the most useful solution would be a reprogrammable non-volatile storage. There are a variety of analog weight storage mechanisms available today, starting with pseudo analog storage utilizing digital memory and DAC's, to direct analog storage using memristors, flash memories, and CTM now being offered in advanced nodes. Tradeoffs relate to the quantization levels, stability, and size of these memories.

CTM devices are promising for an analog storage medium. Most analog storage relies on the use of the resistance of a transistor operating in the linear region, preferable at subthreshold bias. The use of trapped charge allows a global gate bias to have variable effective gate control and therefore reprogrammable but nonvolatile effective resistance. The sum of products function, crucial to any neural net architecture, becomes extremely compact and power efficient.

While fixed hardware architectures for major well-defined applications could be developed as custom ASIC solutions, the ability to reconfigure connection routing would make general purpose analog neural network chips more practical. In general, routing flexibility usually comes at a cost of added parasitic which can degrade analog performance. So, any viable solution most address the programmability with minimum signal degradation. While not required in all fielded applications, in situ weight updates with low power consumption could offer orders of magnitude performance enhancement over current state of the art.

Analog signals can be represented in a system as variable amplitudes, as modulation function (AM, PM, FM, or combination), or as a time duration. Working with time duration or pulse width has advantages in that advanced digital circuit processing nodes offer high precision in timing edges where amplitude control is not as robust. Timing control can be achieved with a single pulse width modulated (PWM) signal, a pair of start and stop pulses, or a count of a number of pulses. Utilizing PWM analog signaling can be one implementation. If all synaptic current is accumulated onto a capacitor, then the signal to kt/C noise limit is directly proportional to the synaptic current budget. A linear ramp equation (1) shows the change in voltage.

ΔV=Δt*I/C (1)

Outputs between stages can be represented by a PWM signal based on the charge and/or discharge time shown by equation (1). Since outputs can be digital levels with varying pulse durations, the outputs can be interfaced with standard digital logic as long as the intrinsic gate delays within a process are much smaller than the desired timing resolution. In many advanced process nodes, the gate delays can be in the single digit picoseconds offering a wide operating range for PWM signals.

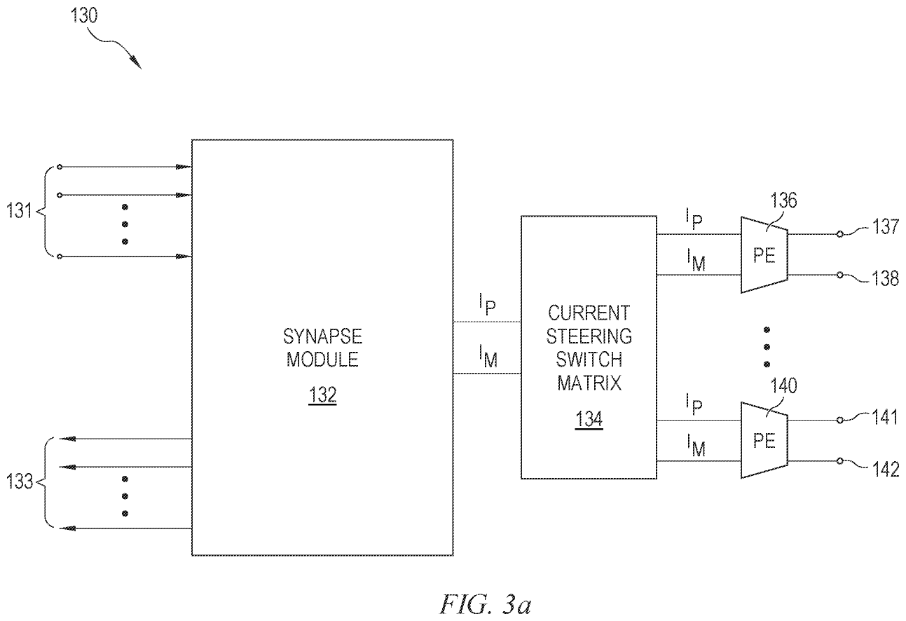

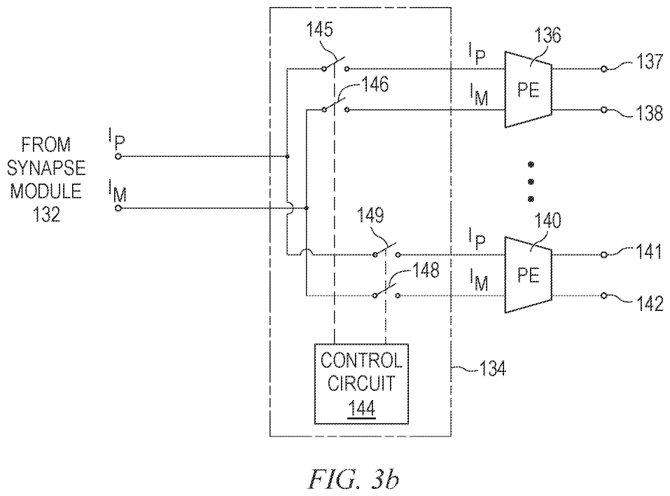

In building a practical and useful ANN, say thousands or even millions of neurons, the complexity of implementing so many discrete neuron processing elements arranged in multiple layers, e.g. from FIG. 2, in a circuit layout on a semiconductor die is highly complex and real estate demanding operation. To address such a high level ANN integration and capability, FIG. 3a illustrates a portion of ANN 130 with shared synapse module 132. Synapse module 132 receives inputs 131 from external sources or previous layers of neurons and provides outputs 133 to external sources or previous layers of neurons. Synapse module 132 performs weighted product operation on the input signal using a plurality of synapse cells, as discussed infra. Current steering switch network 134 provides a multiplexing feature of the output currents I_{P} and I_{M} of synapse module 132 to neuron processing element (PE) 136 and PE 140. Terminal 137 is the output of PE 136, while terminal 138 is an input for backpropagating an error signal when in a training mode. Terminal 141 is the output of PE 140, while terminal 142 is an input for backpropagating an error signal when in a training mode. There can be any number of PEs like 136 and 140.

As noted above, each of neurons 102-112 uses one or more synapses. However, that does not mean that each neuron 102-112 must have its own dedicated synapses. Synapse module 132 contains a plurality of synapse cells that can be shared among a plurality of neuron processing elements such as 136 and 140 in a time interleaved operation. Synapse module 132, current steering switch matrix 134, and PE 136 and 140 can be an implementation of neurons 110 and 112 in layer 124. In fact, by expanding the concept, synapse module 132, current steering switch matrix 134, and additional PEs can be an implementation of multiple neurons 102-112 in multiple layers 120-124. In one embodiment, one synapse module 132 would service one neuron layer containing a plurality of neurons. Each neuron layer would have a synapse module. Alternatively, a first synapse module would service a first portion of the neurons in one neuron layer, and a second synapse module would service a second portion of the neurons in the same neuron layer. In yet another embodiment, synapse module 132 can service multiple neuron layers each containing a plurality of neurons. Since PE 136 and 140 share synapse module 132, and no longer need dedicated synapses, each PE can be made physically smaller and more compact, taking less die area. With synapse module 132 being shared among multiple PEs, in combination with the smaller PEs, ANN 130 has an efficient use of die area. The synapse sharing feature can accommodate a variety of architectures such as the convolution neural network frequently used for image recognition.

FIG. 3b shows a portion of current steering switch matrix 134. In PE 136 mode (PE 136 using synapse module 132), control circuit 144 opens electrical switches 148 and 149 and closes electrical switches 145 and 146 to steer the output currents I_{P} and I_{M} from synapse module 132 to PE 136. In PE 140 mode (PE 140 using synapse module 132), control circuit 144 opens electrical switches 145 and 146 and closes electrical switches 148 and 149 to steer the output currents I_{P} and I_{M} from synapse module 132 to PE 140. During one period of time, PE 136 makes use of the synapses within synapse module 132. During another period of time, PE 140 utilizes the synapses within synapse module 132. Current steering switch matrix 134 steers the synapse output currents I_{P} and I_{M} to the proper PE at the appropriate time. Accordingly, PE 136 and 140 share synapse module 132 in a time interleaved operation.

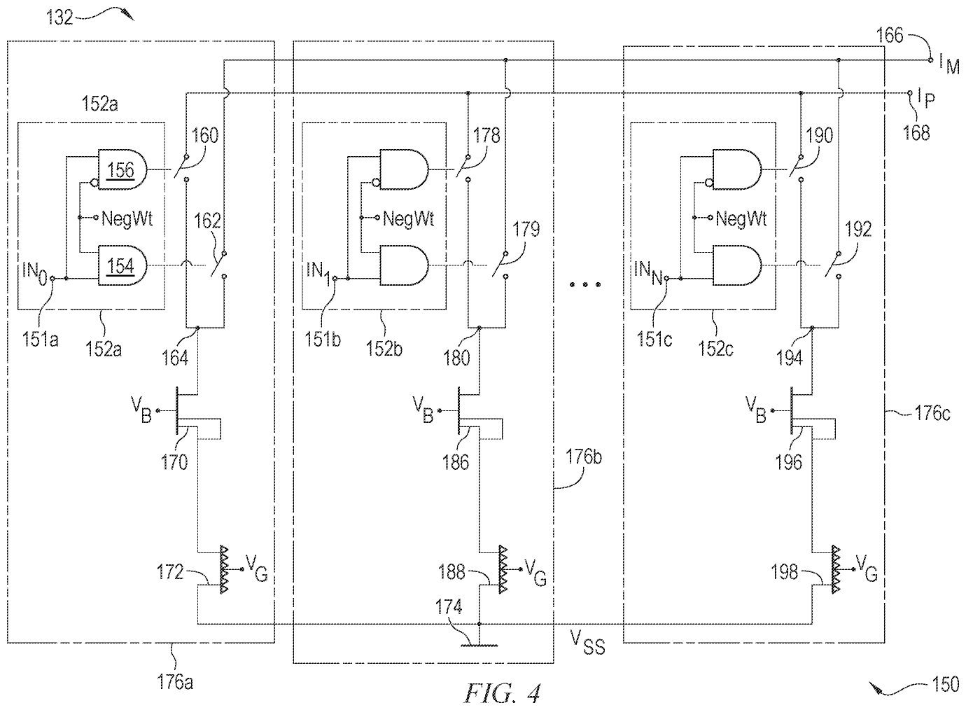

FIG. 4 illustrates further detail of shared synapse module 132 including shunt synapse network 150 containing a plurality of synapse cells 176a-176c, each with a memory feature. Logic circuit 152a includes logic gates 154 and 156 controlling electrical switches 160 and 162. A first input terminal of logic gate 154 and a first input terminal of logic gate 156 receive input signal IN₀ at terminal 151a. A second input terminal of logic gate 154 and a first input terminal of logic gate 156 receive a negative weight signal NEGWT, which would be set high if the weight is intended to be negative, and set low if the weight is intended to be positive. Electrical switches, as described herein, can be implemented with a metal oxide semiconductor (MOS) transistor with the gate being the control terminal and the drain and source being the conduction terminals of the electrical switch. In this case, the conduction paths of electrical switches 160 and 162 are coupled between node 164 and output terminals 168 and 166, respectively. Transistors 170 and 172 are a cascode current source pair coupled between node 164 and power supply conductor 174, operating at V_{SS} or ground potential. The combination of logic circuit 152a, electrical switches 160 and 162, and cascode current source transistor pair 170 and 172 constitute shunt synapse cell 176a.

Shunt synapse cell 176b follows a similar construction and operation as shunt synapse cell 176a with logic circuit 152b receiving input signal IN₁ at terminal 151b. Electrical switches 178 and 179 are coupled between node 180 and output terminals 168 and 166, respectively. Cascode current source transistor pair 186 and 188 are coupled between node 180 and power supply conductor 174. Shunt synapse cell 176c follows a similar construction and operation as shunt synapse cell 176a with logic circuit 152c receiving input signal IN_{N}, where N is any integer, at terminal 151c. Electrical switches 190 and 192 are coupled between node 194 and output terminals 168 and 166, respectively. Cascode current source transistor pair 196 and 198 are coupled between node 194 and power supply conductor 174.

Transistors 172, 188, and 198 operate as analog memory elements, each providing a selectable source of current. A common gate bias V_{G} is used to bias transistors 172, 188, and 198 to operate in a low current mode, such as weak inversion. In the present configuration, all bias potentials are intended to remain constant, independent of any activation signal. A reference generator can be used to generate V_{G} to track the thermal voltage shifts. Transistors 170, 186, and 196 receive a shared cascode bias V_{B} and set the voltage drop across the analog memory elements, i.e., transistors 172, 188, and 198. That is, cascode transistors 170, 186, and 196 isolate the current source transistors 172, 188, and 198 from voltage swings at nodes 164, 180, and 194, respectively. Current source transistors 172, 188, and 198 experience minimal interference from the remainder of synapse cells. In some embodiments, transistors 172, 188, and 198 may have a common back gate bias terminal (not shown). The cascode bias V_{B} or the back-gate bias voltage could also be used to regulate the device behavior over temperature.

Note that in FIG. 4 currents are steered to control I_{P} and I_{M} at output terminals 168 and 166, respectively, as opposed to adjusting voltages which can cause transistor gain error. For example, logic circuit 152a controls electrical switches 160 and 162 to steer positive and negative currents into nodes 166-168. If IN₀ is logic one and NEGWT is logic one, then electrical switch 160 is open and electrical switch 162 is closed. If IN₀ is logic one and NEGWT is logic zero, then electrical switch 160 is closed and electrical switch 162 is open. If IN₀ is logic zero, independent of NEGWT, then electrical switch 160 is open and electrical switch 162 is open. In a similar manner, logic circuit 152b controls electrical switches 178 and 179 to steer positive and negative currents into nodes 166-168. Likewise, logic circuit 152c controls electrical switches 190 and 192 to steer positive and negative currents into nodes 166-168. In any case, the input signal does not propagate through the memory elements like transistors 172, 188, and 198.

Transistors 172, 188, and 198 each have a selectable threshold, even though the transistors have a common V_{G}. Analog programming can cause different effective device thresholds. Temperature variation can cause a device threshold drift that could result in different weights. The relative weight of synapse cell 176a can be controlled by the selected threshold of transistor 172, given the common V_{G}. The relative weight of synapse cell 176b can be controlled by the selected threshold of transistor 188, given the common V_{G}. The relative weight of synapse cell 176c can be controlled by the selected threshold of transistor 198, given the common V_{G}. Alternatively, transistors 172, 188, and 198 each have a common threshold and a selectable V_{G}, or transistors 172, 188, and 198 each have a selectable threshold and a selectable V_{G}. In any case, each synapse cell 176a-176c has an independently controllable weight.

Synapse cells 176a-176c are comprised of logic circuits and NMOS and PMOS transistors, which can be implemented on a semiconductor die with nanometer-scale resolution or less. The NMOS devices should be biased for minimum operating VSAT requirements. Accordingly, a large number of synapse cells of network 150 and synapse module 132, e.g. thousands to millions, can be practical in the active area of the semiconductor die.

Neurons 102-112 of ANN 100 use one or more synapse cells like 176a-176c. More specifically, PE 136 and 140 both utilize and share synapse module 132 containing one or more synapse cells like 176a-176c, as described in FIGS. 3a-3b, to implement, for example, neurons 110-112 of ANN 100. Given the above timing, the net current at any point in time would reflect the current state of the synapse current, and not its product with the input level. A summation of charge would represent the correct sum of products terms.

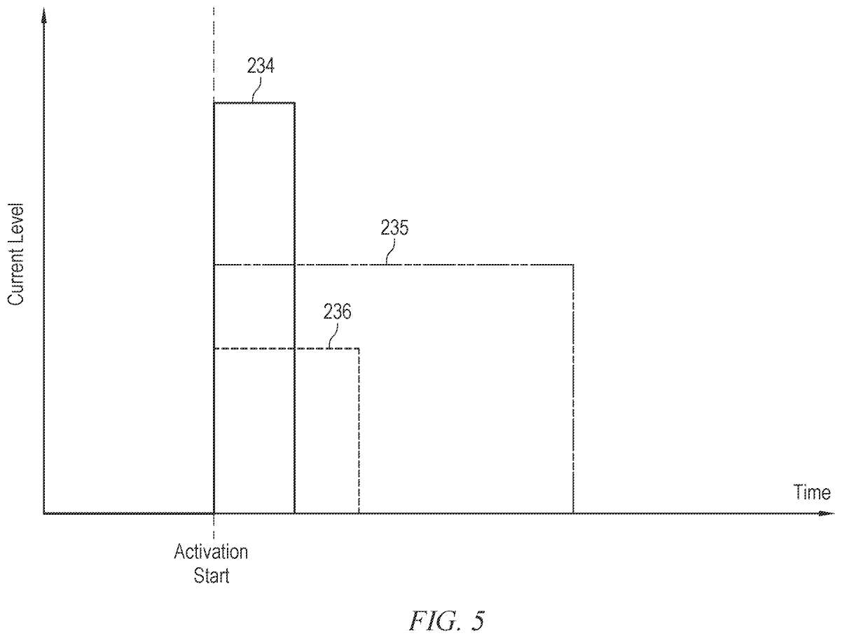

FIG. 5 illustrates a principal of operation of synapse cells 176a-176c from FIG. 4. The analog activation signals are digital signals with the analog strength represented by the time duration or pulse width, such as in a PWM OUT signal, discussed in detail below. The PWM OUT signal represents the activation level of a neuron and, more specifically, a neuron from a previous layer when coupled into a synapse module, represented as an input signal IN₀ to IN_{N}. The rising edge of PWM OUT is the activation start and the pulse width of PWM OUT is the state or level, i.e., data or information content, of the previous layer. There may be one PWM OUT common for all IN₀-IN_{N}, or separate PWM OUT signals for each IN₀-IN_{N}. That is, once the previous neuron layer has completed its processing, IN₀ is the activation PWM OUT signal received at terminal 151a from the previous neuron layer to activate logic gates 152a and conduct synapse processing in the present neuron layer. Likewise, IN₁ is the activation PWM OUT signal received at terminal 151b from the previous neuron layer to activate logic gates 152b and conduct synapse processing in the present neuron layer. IN_{N} is the activation PWM OUT signal received at terminal 151c from the previous neuron layer to activate logic gates 152c and conduct synapse processing in the present neuron layer. The input signals IN₀ to IN_{N} act as gates to the weighted current sources represented by the analog memory and cascode circuit. In addition, the NEGWT bit switches the current to either the positive or negative current nodes 166-168. The pulse starts will preferably be aligned with an activation PWM OUT signal. The multiplication in the above configuration is a product of the pulse width times the strength of the current achieved through the analog memory. Waveform 234 illustrates a strong weight and high current over a short duration pulse width. Waveform 235 illustrates a medium weight and medium current over a long duration pulse width. Waveform 236 illustrates a lower weight and low current over a medium duration pulse width. The longer the duration of the pulse width and the larger the weight of the synapse, the more influence of that synapse on the next processing element. The shorter the duration of the pulse width and the smaller the weight of the synapse, the less influence of that synapse on the next processing element. Again, the weight of the synapse is set by the selectable current of analog memory transistors 172, 188, and 198. The nature of the above multiplication is that current may be short or long durations, and high or low magnitudes. Each synapse 176a-176c can independently exhibit the behavior of any of the waveforms 234-236, as well as any other weight profile.

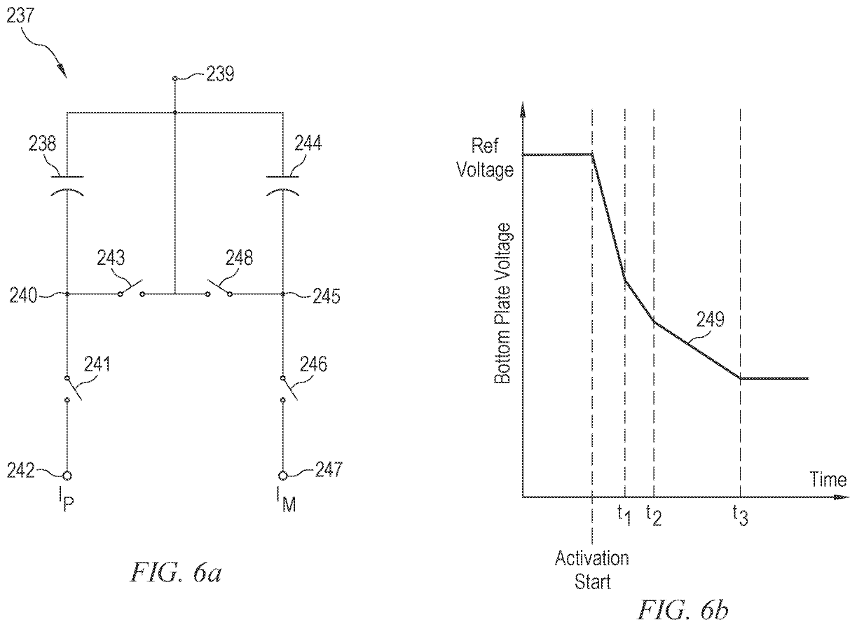

FIG. 6a is a simplified view of PE 136 and 140 demonstrated with capacitor network 237. Capacitor 238 is coupled between reference voltage 239 and node 240. Electrical switch 241 is coupled between node 240 and terminal 242 receiving positive current I_{P}, representing current from one or more of synapse cells 176a-176c. Electrical switch 243 is coupled between node 240 and reference voltage 239. Capacitor 244 is coupled between reference voltage 239 and node 245. Electrical switch 246 is coupled between node 245 and terminal 247 receiving negative current I_{M}, representing current from one or more of synapse cells 176a-176c. In one embodiment, terminal 242 is coupled to output terminal 168 and terminal 247 is coupled to output terminal 166. Electrical switch 248 is coupled between node 245 and reference voltage 239.

During phase one, electrical switches 243 and 248 are closed and capacitors 238 and 244 are discharged. Electrical switches 243 and 248 are then opened. In phase two, electrical switches 241 and 246 are closed to an initiate activation start. Reference voltage 239 can be ground, the positive supply, or any voltage level that is compliant with the electrical switches. In one embodiment, the current discharge from shunt synapse cells 176a-176c creates a negative voltage relative to reference voltage 239.

The discharge waveform for the synapse current in FIG. 5 is shown in FIG. 6b. Waveform 249 exhibits the maximum slope when waveforms 234-236 are all active up to time t₁. Waveform 249 reduces slope when waveform 234 ends and waveforms 235-236 remain active between times t₁ and t₂. Waveform 249 reduces slope again when waveforms 234-235 end and waveform 236 remains active between times t₂ and t₃. Waveform 249 reaches final minimum slope or settled value when waveforms 234-236 all end after between time t₃. The currents associated with waveforms 234-236 operate independently, asynchronously, each with potentially different magnitudes and durations.

In the above configuration two capacitors are used, one for positive weights, and one for negative weights and the threshold function. The voltage on capacitor 238 and 244 is a function of current flow and time. During generation of an output activation level using the rectified linear unit (RELU) activation function, a pulse width can be made proportional to a linear reduction of capacitor 238 charge until it crosses over the voltage of capacitor 244, or proportional to a linear increase of capacitor 244 charge until it passes the voltage stored on capacitor 238. The fixed reference current for the operation can be adjusted to allow for retiming of the next stage activation levels.

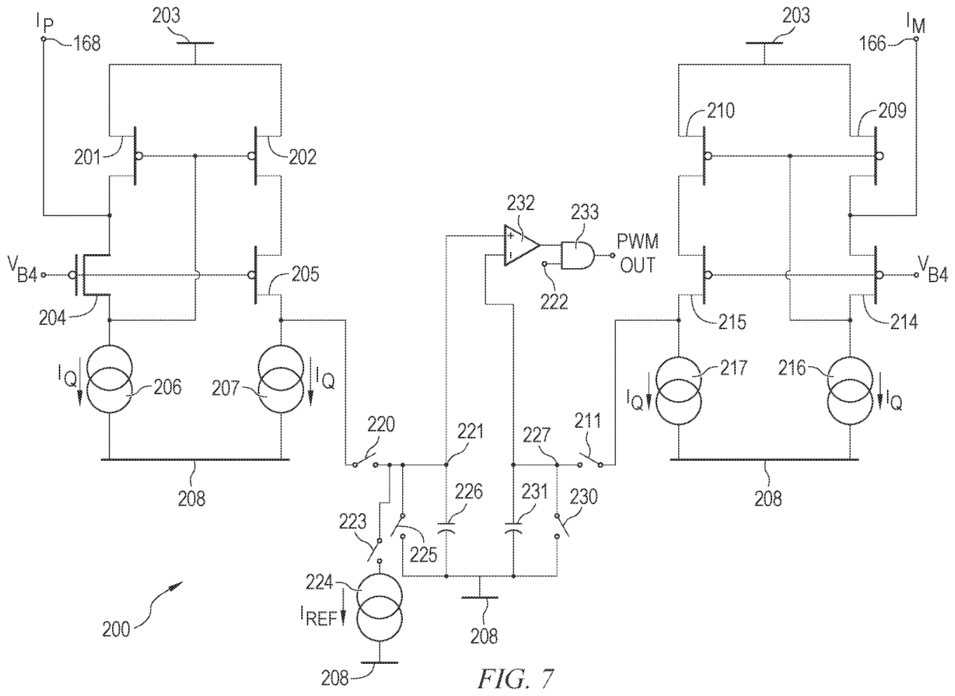

FIG. 7 illustrates a further description and schematic of PE 136 and 140 performing a sum of products operation on output currents I_{P} and I_{M} and providing the next layer activation PWM OUT. In circuit 200, transistor 201 receives current I_{P} from terminal 168 at its drain. The sources of transistors 201 and 202 are coupled to power supply conductor 203 operating at V_{DD}. Transistors 204 and 205 receive bias potential VB4. Current source 206 is coupled to the drain of transistor 204 and common gate of transistors 201 and 202. Current source 206 is referenced to power supply conductor 208 operating at V_{SS} or ground potential and conducts current I_{Q}. Current source 207 is coupled to the drain of transistor 205. Current source 207 is referenced to power supply conductor 208 and conducts current I_{Q}. Transistor 209 receives current I_{M} from terminal 166 at its drain. The sources of transistors 209 and 210 are coupled to power supply conductor 203 operating at V_{DD}. Transistors 215 and 216 receive bias potential VB4. Current source 216 is coupled to the drain of transistor 214 and common gate of transistors 209 and 210. Current source 216 is referenced to power supply conductor 208 and conducts current I_{Q}. Current source 217 is coupled to the drain of transistor 215. Current source 217 is referenced to power supply conductor 208 and conducts current I_{Q}. The current I_{Q} is a minimum biasing current that gets subtracted out from the functional operation.

Electrical switch 220 is coupled between the drain of transistor 205 and node 221. Electrical switch 223 is coupled between node 221 and current source 224, referenced to power supply conductor 208. Current source 224 conducts reference current I_{REF}. Electrical switch 225 is coupled between node 221 and power supply conductor 208. Capacitor 226 is coupled between node 221 and power supply conductor 208. Electrical switch 211 is coupled between the drain of transistor 215 and node 227. Reference current I_{REF} is not part of the weighted sum of products terms but can be varied to trade off accuracy for operating speed. A lower value of I_{REF} allows a longer discharge time and better timing resolution, while a higher value of I_{REF} provides a faster discharge time and overall operation, at the expense of some timing resolution. Electrical switch 230 is coupled between node 227 and power supply conductor 208. Capacitor 231 is coupled between node 227 and power supply conductor 208. Comparator 232 has a non-inverting input coupled to node 221 and an inverting input coupled to node 227. The output of comparator 232 is coupled to a first input of AND gate 233, while a second input of the AND gate receives a timing signal. The output of AND gate 233 is PWM OUT.

Each layer can have three phases of operation. Phase one is a reset phase, phase two is a pre-charge phase, and phase three is the output activation phase. It should be noted that when one layer, or a subset of neurons in a layer, are in phase two, or the pre-charge phase, the preceding layer would be operating in phase three, or the activation phase. Multiple neurons may be pre-charged either in synchronously or sequentially during phase two, and then synchronously transition to the activation output mode by transitioning to phase three.

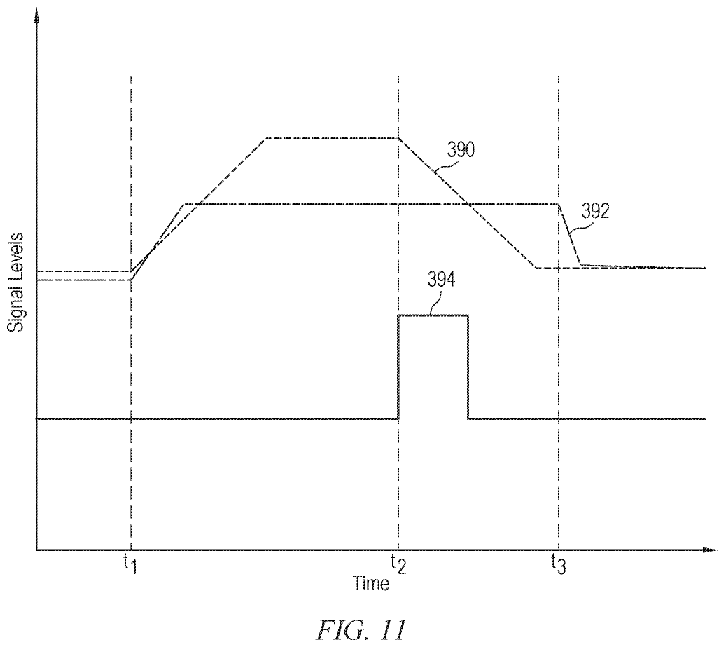

During phase one, electrical switches 225 and 230 are closed to discharge capacitors 226 and 231. Electrical switches 225 and 230 are then opened. During phase two, electrical switches 220 and 211 are closed to pre-charge capacitors 226 and 231 based on synapse output current I_{P} and I_{M}, similar to times t₁ to t₂ in FIG. 11. During phase three, electrical switch 223 is closed, as well as asserting the timing signal at terminal 222, to generate the PWM OUT signal, similar to after time t₂ in FIG. 11. PWM OUT has a rising edge for activation start of the next neuron in the next layer. The initial rise time of PWM OUT is an activation start that lets the next layer know that the operations are complete and its output signals are valid for the next layer to begin processing. PWM OUT has a pulse width as determined by the discharge rate of capacitor 226, and the difference of voltages set on capacitor 226 and capacitor 231, which were pre-charged during phase two using the currents I_{P} and I_{M}, as set by the weights of the present synapses 176a-176c and the outputs of the previous neuron, i.e., previous PWM OUT controlling logic gates 152a-152c in the present neuron. The width of the PWM OUT pulse contains data for the next neuron layer. PWM OUT will then control logic gates like 152a-152c in synapse cells like 176a-176c of the next neuron in the next layer to steer current from the analog memory transistor like 172, 188, and 198 to generate the currents I_{P} and I_{M} in the next neuron in the next layer.

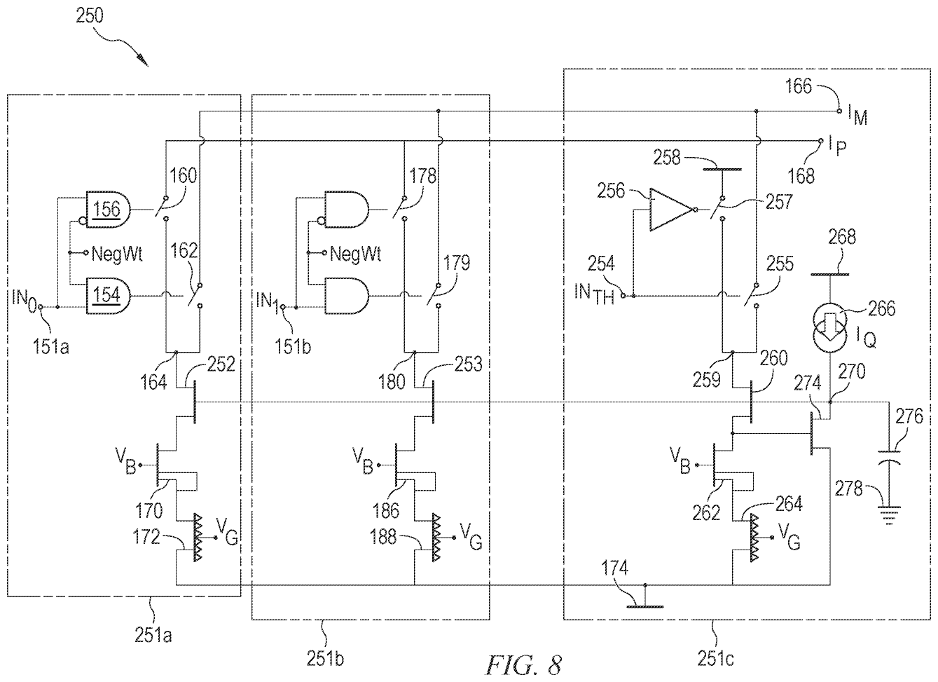

When the sinking current is used directly from the current synapses 176a-176c, gain compression may occur due to the drain of the cascode transistors like 170-172 being subject to voltage variations due to the capacitor ramp voltage and/or initial bias conditions. FIG. 8 illustrates another embodiment of synapse network 250 with an active cascode configuration to address gain compression and improve linearity. Synapse cell 251a follows a similar structure as synapse cell 176a with the addition of cascode transistor 252. Circuit elements having a similar function are assigned the same reference number. Likewise, synapse cell 251b follows a similar structure as synapse cell 176b with the addition of cascode transistor 253. Additional synapse cells (not shown) in FIG. 8 would be similar to synapse cells 176a-176c in FIG. 4 with the additional active cascode transistor like 252-253. Neurons 102-112 of ANN 100 would contain one or more synapse cells like 251a-251b.

To set up the active cascode transistor control, a specialized synapse cell 251c in synapse network 250 dedicated to maintaining the threshold for the active cascode transistors like 251 and 252. The PWM OUT pulse for synapse cell 251c would have a maximum duration. The input threshold signal IN_{TH} at terminal 254 directly controls electrical switch 255 and is inverted by inverter 256 to control electrical switch 257. Electrical switch 257 is coupled between power supply conductor 258, operating at a positive potential such as V_{DD}, and node 259. Electrical switch 255 is coupled between output terminal 166 and node 259. Transistor 260 is in a cascode arrangement with transistors 262 and 264. Current source 266 provides a constant current I_{Q} to node 270 at the gate of transistor 260. The current I_{Q} is a minimum bias current for the active cascode transistors 252, 253, and 260. Transistor 274 has a drain coupled to node 270, source coupled to power supply conductor 174, and gate coupled to the source of transistor 260. Capacitor 276 is coupled between node 270 and power supply conductor 278, operating at ground potential. Capacitor 276 is a filtering element to compensate and stabilize node 270 and maintain a constant bias voltage for the active cascode transistors 252, 253, and 260.

Synapse cell 251c shows a portion of the full differential operation with electrical switch 255 coupled to output terminal 166. Another specialized synapse cell, similar to 251c, or portion thereof, would be connected to output terminal 168 for full differential operation.

During normal operation, IN_{TH} is logic one and electrical switch 255 is closed to connect the drain of transistor 260 to output terminal 166. Transistor 274 forces the drain of transistor 260 to maintain about a voltage threshold level. When all electrical switches like 160, 162, 178, 179 coupling to terminals 166 and 168 are open, node 270 is pulled to the positive rail. The loop needs to recover during activation. To increase the loop speed, IN_{TH} can be set to logic zero to close electrical switch 254 and connect the drain of transistor 260 to power supply conductor 258 to source current into node 270 between cycles. Transistor 274 senses any variation in the voltage at node 270 and compensates for such variation to regulate the node. IN_{TH} is hard coded DC to establish the threshold to scale product terms, either dump current or pull off one side of terminals 166 or 168. Portions of synapse cell 251c would be duplicated for output terminal 168.

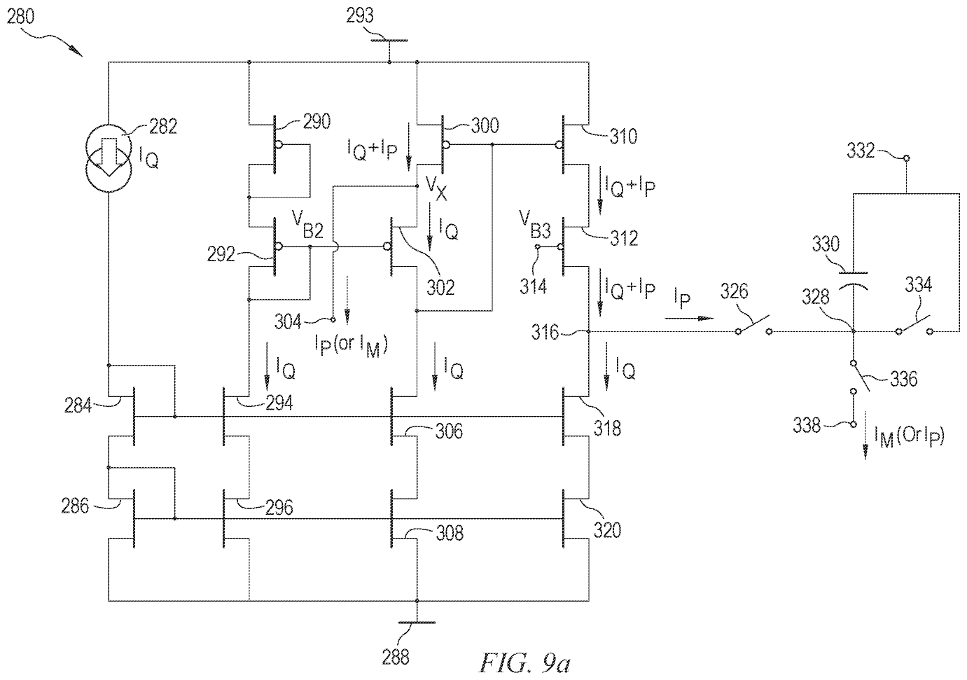

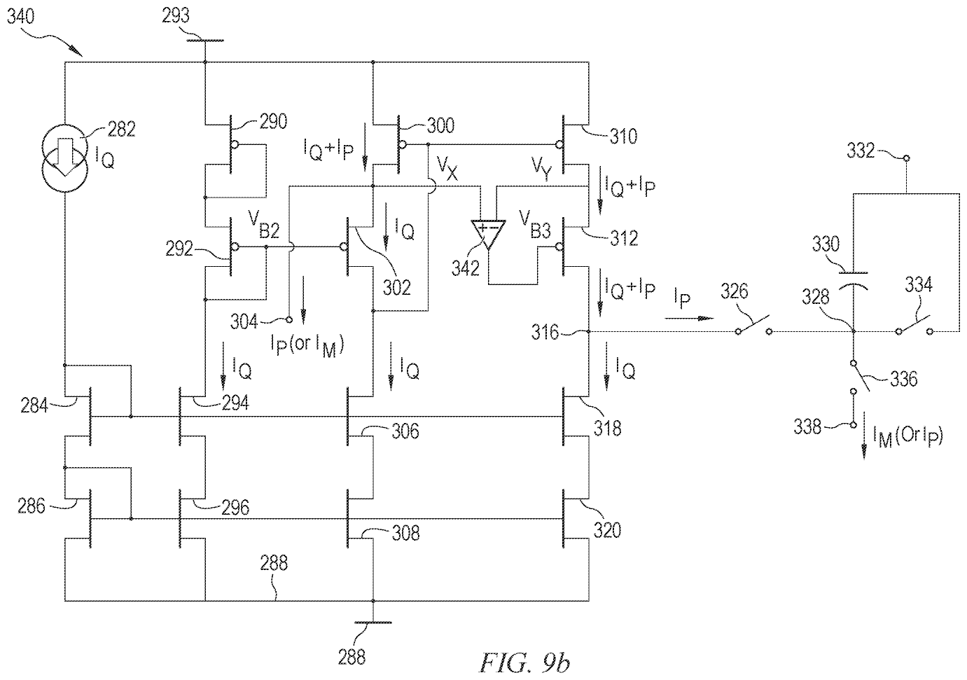

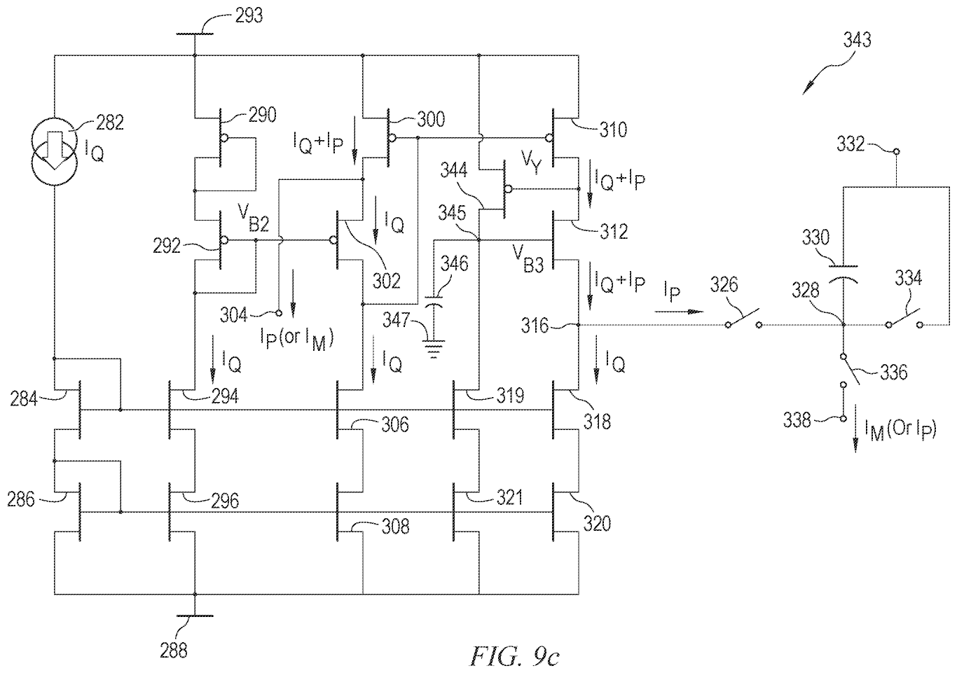

In another embodiment, it may be desired to sum positive and negative currents onto a single capacitor. The positive or negative synapse current would need to be flipped to a sourcing current while the other remains a sinking current. FIG. 9a illustrates polarity inversion circuit 280 to accomplish such a polarity inversion or flip. Polarity inversion circuit 280 has a current source 282 providing a constant current I_{Q} as a minimum bias current. Current I_{Q} flows through diode-connected transistors 284 and 286 referenced to power supply conductor 288, operating at V_{SS} or ground potential. Diode-connected transistors 290 and 292 are coupled between power supply conductor 293 and cascode transistors 294 and 296. Transistors 290, 292, 294, and 296 conduct current I_{Q}. Transistor 300 has a source coupled to power supply conductor 293 and a drain coupled to the source of transistor 302 at terminal 304. Transistor 302 receives bias voltage VB2 at its gate terminal from diode-connected transistors 290-292 and conducts current I_{Q}. Terminal 304 receives a sinking current I_{P}, representing current from one or more of synapse cells 176a-176c, i.e., terminal 304 is coupled to output terminal 168. Alternatively, terminal 304 receives a sinking current I_{M}, representing current from one or more of synapse cells 176a-176c, i.e., terminal 304 is coupled to output terminal 166. The voltage at node 304 is regulated by the source of transistor 302 with its fixed bias VB2. Given current I_{P} at terminal 304 and I_{Q} flowing in transistor 302, transistor 300 must conduct I_{P}+I_{Q}. The drain of transistor 302 is coupled to the gate of transistor 300 and provides current I_{Q} to cascode transistors 306 and 308 by nature of diode-connected transistors 284-286. In the most basic form, current mirror arrangement of transistors 300, 302, 310, and 312, transistors 310 and 312 would be equivalently sized to each conduct current I_{P}+I_{Q} into node 316, with a bias voltage VB3 for the gate of transistor 312 at terminal 314. Cascode transistors 318 and 320 conduct current I_{Q} by nature of diode-connected transistors 284-286. With current I_{P}+I_{Q} flowing into node 316 and I_{Q} flowing through cascode transistors 318 and 320, then current I_{P} flows through electrical switch 326 into node 328. However, instead of current I_{P} being a sinking current in terminal 304, current I_{P} is now a sourcing current into node 328. Hence, the polarity has inverted and current I_{P} inversion can now be directly compared to current I_{M}.

Capacitor 330 is coupled between reference voltage 332 and node 328. Electrical switch 334 is coupled between reference voltage 332 and node 328 to discharge capacitor 330. With electrical switches 326 and 336 closed, the polarity of current I_{P} is inverted to current I_{M} at terminal 338 and the single capacitor would store the difference of the accumulated I_{P} and I_{M} currents. If current I_{M} had been sourced into terminal 304, then polarity inversion circuit 280 would have inverted the polarity of current I_{M} to current I_{P} at terminal 338. Reference voltage 332 for the initial state of capacitor 330 should consider the compliance range of electrical switches 326, 334, and 336 with respect to positive and negative excursions.

One feature of polarity inversion circuit 280 is that transistor 302 sets a constant voltage at the drain of transistor 300 to reduce or eliminate any drain compression on the current synapse, and provides significant headroom for operating shunt current synapse with limited supply voltages that are common in advanced semiconductor process nodes. Another feature is that the synapse weight currents do not see significant voltage swings that could cause a nonlinear compression due to finite output impedance. The current mirror structure 300, 302, 310, and 312 could be applied to both current I_{P} and I_{M} in order to reduce voltage ramp induced gain compression, rather than flipping one of the current directions. The current mirror block flips the I_{P} current from sink to source direction and when summed with the sinking I_{M} current on capacitor 330 is equivalent to I_{P}−I_{M}.

If VB3 were to be set equal to VB2, then the varying current in transistor 312 may induce gain compression into transistor 310. To actively bias VB3, another polarity inversion circuit 340 involves using negative feedback to bias VB3, as shown in FIG. 9b. Again, circuit elements having a similar function are assigned the same reference number. In this case, amplifier 342 has a non-inverting input coupled to terminal 304 and an inverting input coupled to the drain of transistor 310. The output of amplifier 342 is coupled to the gate of transistor 312 to actively control bias VB3.

FIG. 9c is another approach with polarity inversion circuit 343. Transistor 344 can be an implementation of the concept of amplifier 342 with its source coupled to power supply conductor 293 and its drain coupled to node 345. Capacitor 346 is coupled between node 345 and power supply conductor 347, operating at ground potential. Cascode transistors 319 and 321 are coupled between node 345 and power supply conductor 288. The drain of transistor 344 actively controls bias VB3.

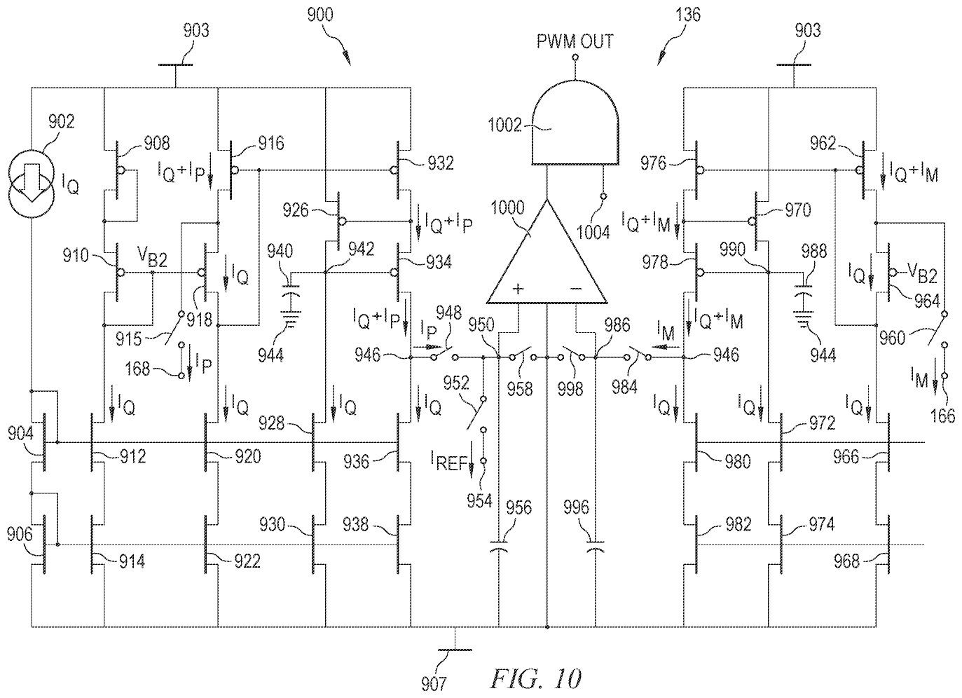

FIG. 10 illustrates an embodiment of the polarity inversion circuits from FIG. 9a-9c in PE 136 and 140. In circuit 900, current source 902 provides current I_{Q} from power supply conductor 903 operating at V_{DD} to diode-connected transistors 904 and 906, referenced to power supply conductor 907, operating at V_{SS} or ground potential. The current I_{Q} is a minimum bias current. Transistors 908, 910, 912, and 914 also conduct current I_{Q}. Terminal 168 is coupled through electrical switch 915 to the drain of transistor 916 and source of transistor 918 to sink current I_{P}. Since transistors 920 and 922 conduct current I_{Q}, transistor 916 conducts I_{P}+I_{Q}. Transistors 926, 928, and 930 conduct current I_{Q}. Transistors 932 and 934 conduct I_{P}+I_{Q}, and transistors 936 and 938 conduct current I_{Q}, leaving current I_{P} sourced through electrical switch 948 to node 950. Capacitor 940 is coupled between node 942 and power supply conductor 944, operating at ground potential. Electrical switch 952 is coupled between node 950 and terminal 954 sinking I_{REF}. Capacitor 956 is coupled between node 950 and power supply conductor 907. Electrical switch 958 is coupled between node 950 and power supply conductor 907. Terminal 166 is coupled through electrical switch 960 to the drain of transistor 962 and source of transistor 964 to sink current I_{M}. The gate of transistor 964 is coupled to the gate of transistor 910. The gates of transistors 966 and 968 are coupled to the gates of transistors 904 and 906 and conduct current I_{Q}. Transistors 970, 972, and 974 conduct current I_{Q}. Transistors 976 and 978 conduct I_{M}+I_{Q}, and transistors 980 and 982 conduct current I_{Q}, leaving current I_{M} sourced through electrical switch 984 to node 986. Capacitor 988 is coupled between node 990 and power supply conductor 944. Capacitor 996 is coupled between node 986 and power supply conductor 907. Electrical switch 998 is coupled between node 986 and power supply conductor 907. The non-inverting input of comparator 1000 is coupled to node 950 and the inverting input of the comparator is coupled to node 986. The output of comparator 1000 is coupled to a first input of AND gate 1002. A second input of AND gate 1002 receives a timing signal at terminal 1004. The output of AND gate 1002 is the PWM OUT signal.

During phase one, electrical switches 958 and 998 are closed to discharge capacitors 956 and 996. Electrical switches 958 and 998 are then opened. During phase two, electrical switches 948 and 984 are closed to pre-charge capacitors 956 and 996 based on synapse output current I_{P} and I_{M}, similar to times t₁ to t₂ in FIG. 11. During phase three, electrical switch 952 is closed, as well as asserting the timing signal at terminal 1004, to generate the PWM OUT signal, similar to after time t₂ in FIG. 11. PWM OUT has a rising edge for activation start of the next neuron in the next layer. The initial rise time of PWM OUT is an activation start that lets the next layer know that the operations are complete and its output signals are valid for the next layer to begin processing. PWM OUT has a pulse width as determined by the discharge rate of capacitor 956, and the difference of voltages set on capacitor 956 and capacitor 996, which were pre-charged during phase two using the currents I_{P} and I_{M}, as set by the weights of the present synapses 176a-176c and the outputs of the previous neuron, i.e., previous PWM OUT controlling logic gates 152a-152c in the present neuron. The width of the PWM OUT pulse contains data for the next neuron layer. PWM OUT will then control logic gates like 152a-152c in synapse cells like 176a-176c of the next neuron in the next layer to steer current from the analog memory transistor like 172, 188, and 198 to generate the currents I_{P} and I_{M} in the next neuron in the next layer.

The voltage stored on capacitors 956 and 996 is the net sum of charge/capacitance. To deplete the amount of charge, a fixed reference current is used and is converted to time based on the relationship in equation (2).

Time=Capacitance*StoredVoltage/IReference (2)

Referring to FIG. 11, waveform 390 is the charge on capacitor 956 and waveform 392 is the charge on capacitor 996. Before time t₁, electrical switches 958 and 998 are closed to discharge capacitors 956 and 996. A start signal initiates the charge depletion operation. Terminal 1004 is logic zero before time t₁. Between times t₁ and t₂, capacitors 956 and 996 are pre-charged with the sum of products from the synaptic current sources. Electrical switches 958 and 998 are open and electrical switches 948 and 984 close for the synapse activation period. At time t₂, electrical switch 952 is closed to sink I_{REF}. Also, at time t₂, AND gate 1002 receives logic one from terminal 1004 to activate the gate. If the pre-charged node 950 is greater than node 986, the output signal of comparator goes to a high state, which in combination with the logic one from terminal 1004, asserts PWM OUT in waveform 394. In other words, the PWM OUT output pulse is asserted when the start signal is detected if the accumulated charge across capacitor 950 is greater than the charge across capacitor 996. Reference current I_{REF} with electrical switch 952 draws current from capacitor 956 until the inputs cross each other signaling the end of the output pulse period and then de-asserts the output pulse. That is, when waveform 390 falls below waveform 392, the output signal of comparator 1002 switches back to a low state to de-assert PWM OUT in waveform 394. After time t₃, electrical switches 958 and 998 are closed to discharge capacitors 956 and 996 and restart the sequence. The reference current I_{REF} can be used to rescale the pulse timing between layers if needed.

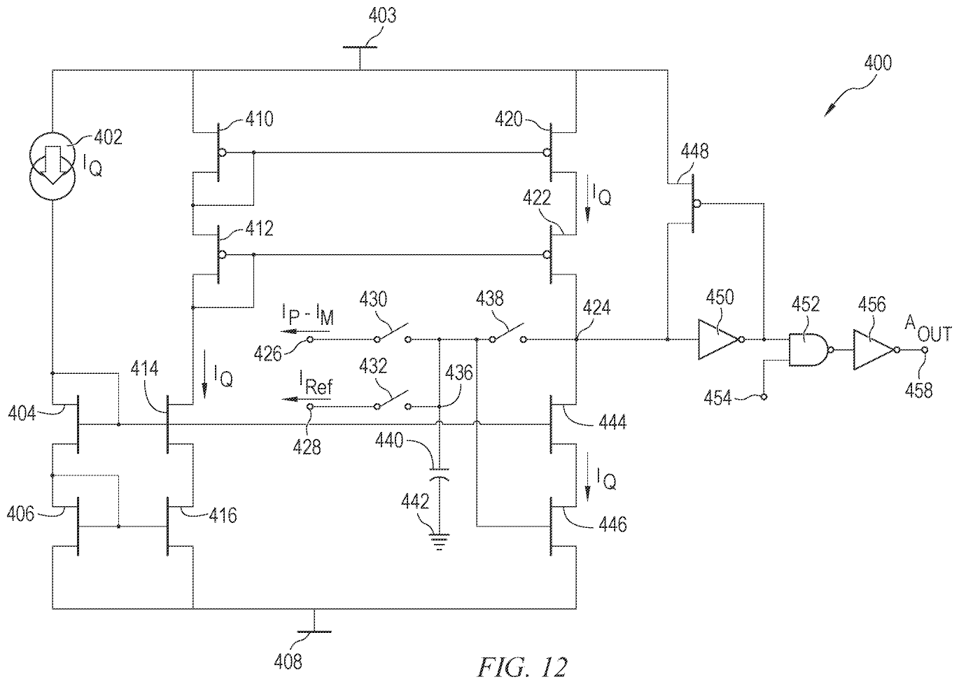

FIG. 12 shows another embodiment of activation circuit 400 using a single capacitor to generate the PWM OUT pulse. When summing positive and negative current polarities onto a single capacitor, a comparator must compare the charge depletion against a trip point reference. Current source 402, referenced to power supply conductor 403 operating at a positive voltage V_{DD}, provides current I_{Q} as a minimal bias current to diode-connected transistors 404 and 406. Transistors 404 and 406 are referenced to power supply conductor 408, operating at V_{SS} or ground potential. Transistors 414 and 416 conduct the same current I_{Q} as do diode-connected transistors 410 and 412. Likewise, cascode transistors 420 and 422 conduct current I_{Q} to node 424 by nature of diode-connected transistors 410 and 412. Terminal 426 receives current I_{P}−I_{M}, which is routed through electrical switch 430 to node 436. Terminal 428 receives current I_{REF}, which is routed through electrical switch 432 to node 436. Electrical switch 438 is coupled between node 436 and node 424. Capacitor 440 is coupled between node 436 and power supply conductor 442, operating at ground potential. Transistors 444 and 446 are coupled between node 424 and power supply conductor 408. The gate of transistor 444 is coupled to the gate of transistor 404, and the gate of transistor 446 is coupled to node 436. Transistor 448 has its source coupled to power supply conductor 403 and drain coupled to node 424. Inverter 450 is coupled between node 424 and the gate of transistor 448 and a first input of NAND gate 452. A second input of NAND gate 452 receives a timing signal at terminal 454. The output of NAND gate 452 is coupled through inverter 456 to terminal 458 to provide AOUT.

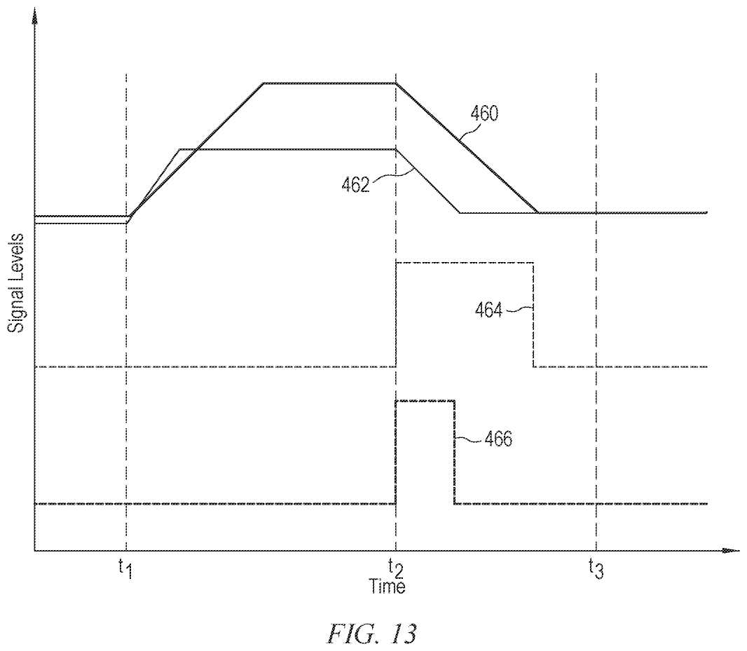

Referring to FIG. 13, waveforms 460 and 462 represent the charge on capacitor 440 in different scenarios. Before time t₁, transistor 446 is put into a diode configuration and the voltage generated is the critical trip point for the first gain stage. If the process supports back gate modified device thresholds, transistor 446 should be biased for a large device threshold to enable adequate saturation voltage of the sinking current sources. Capacitor 440 is pre-charged to the device threshold. Between times t₁ and t₂, electrical switch 430 is closed and capacitor 440 is charged to the net sum of current I_{P}−I_{M}, where I_{P} is a sourcing current, and I_{M} is a sinking current. If the accumulated sourcing current is greater than the accumulated sinking current, then capacitor 440 will have a higher voltage than during its reset phase, causing the output of inverter 450 to go high. At time t₂, input 454 to NAND gate 452 is brought high, electrical switch 430 is opened, and switch 432 is closed, and capacitor 440 is discharged by reference current I_{REF}. If the sourcing current I_{P} is greater than the sinking current I_{M}, the voltage on capacitor 440 will be higher than its threshold level and the output signal AOUT at terminal 458 goes high as in waveform 464. Waveform 464 is associated with waveform 460, and waveform 466 is associated with waveform 462. When the capacitor level crosses below the initial pre-charge level, the output of the 1st gain stage 424 pulls high. At this point, transistor 448 is turned on creating a unidirectional hysteresis solidly driving the output low.

In one embodiment, PE 480 and 490 can be similar to PE 136 and 140. In some situations, synapse values can be held for some time, e.g. as a voltage on a capacitor. Current steering switch network 478 can reuse some of those values to make the processing more efficient.

The semiconductor die layout would couple an input layer (either directly from off chip, or from some sensor array on chip) through a first synapse network module. There may be an input conditioning layer before the first synapse network module to put the data in the right format, namely a PWM representation of an analog level that has a controlled starting point. The system can operate on either two clock phases (either using a synchronizing clock or self-timed), but three or more specific phases may provide greater control.

Since the PE module stores the sum of products value and only outputs its activation value on a gated signal, this opens the possibility to share a synapse network module with two or more PE modules and then synchronize the output of the multiple modules with a gating control signal. This can be achieved as the current from the synapses pass through a switch before charging up the capacitor. As long as adequate settling time is allowed, no loss occurs in the switches. To multiplex two or more PE modules to a synapse, selection logic is used to enable the switches coupling the capacitors in the PE Module to the synapse network. Then each capacitor associated within a PE module stores the charge until the select number of PE modules are charged, and then can release their output pulses upon receiving a timing control signal. This can be beneficial as the synapse module is expected to take the majority of the area when large number of interconnects are involved.

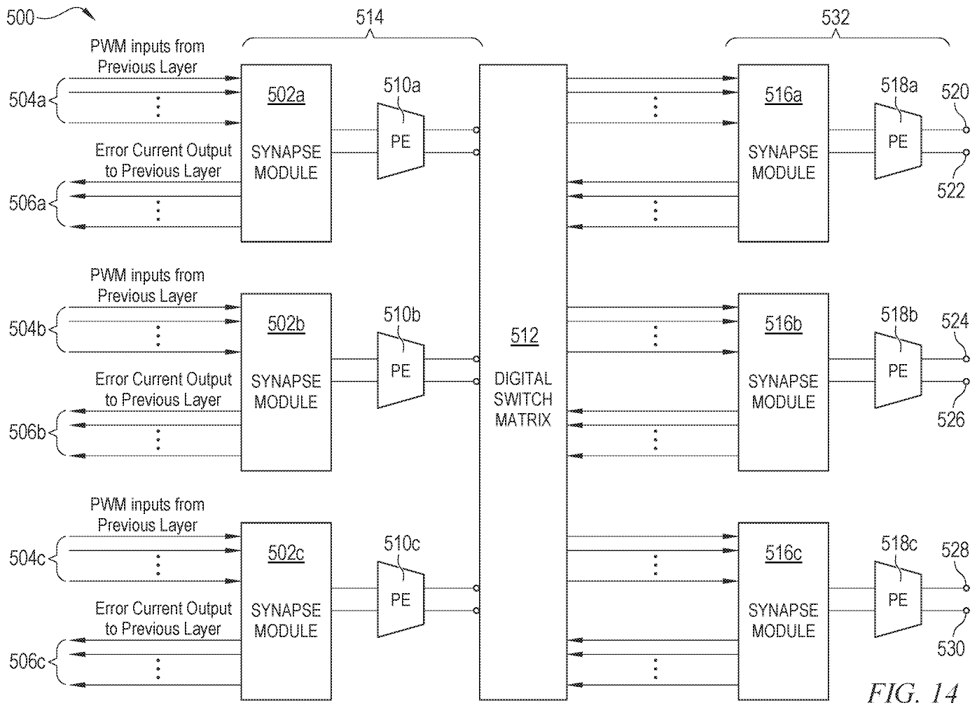

FIG. 14 illustrates ANN 500 with a programmable interlayer interconnect structure. Synapse module 502a contains synapse network 150 from FIG. 4 or synapse network 250 from FIG. 8. Synapse module 502a receives inputs 504a in the form of a digital PWM signal from a previous layer and provides error current outputs 506a to the previous layer that can be used for training methods such as backpropagation. Synapse module 502b receives inputs 504b in the form of a digital PWM signal from a previous layer and provides error current outputs 506b to the previous layer. Synapse module 502c receives inputs 504c in the form of a digital PWM signal from a previous layer and provides error current outputs 506c to the previous layer. PE 510a receives the output of synapse module 502a and provides a PWM pulse out to the digital switch matrix 512. Likewise, PE 510b receives the output of synapse module 502b and provides a PWM pulse out to the digital switch matrix 512. PE 510c receives the output of synapse module 502c and provides a PWM pulse out to the digital switch matrix 512. PE 510a-510c can be similar to PE 136 and 140. Synapse modules 502a-502c and PE 510a-510c represent layer 514.

In the next layer 532, synapse module 516a contains synapse network 150 from FIG. 4 or synapse network 250 from FIG. 8. Synapse module 516a receives inputs from layer 514 through digital switch matrix 512 and provides error current feedback to layer 514 during training modes through the digital switch matrix. Synapse module 516b receives inputs from layer 514 through digital switch matrix 512 and provides error current feedback to layer 514 during training modes through the digital switch matrix. Synapse module 516c receives inputs from layer 514 through digital switch matrix 512 and provides error current feedback to layer 514 during training modes through the digital switch matrix. PE 518a receives the output of synapse module 516a and provides a PWM pulse out 520 to the next layer or next switch matrix. Likewise, PE 518b receives the output of synapse module 516b and provides a PWM pulse out 524 to the next layer or next switch matrix. PE 518c receives the output of synapse module 516c and provides a PWM pulse out 528 to the next layer or next switch matrix. PE 518a-518c can be similar to PE 136 and 140. Synapse modules 516a-516c and PE 518a-518c represent layer 532. Accordingly, digital switch matrix 512 provides the ability to switch signals in and among different synapse processing layers 514 and 532.

While analog memory is very specialized, digital memory and logic is common and can be very compact in advanced process nodes. As the analog output activation layer is converted to a digital amplitude with a specific pulse width, these pulses can be gated with standard logic and path selection signals. This allows the control of a synapse switch element to be defined as the combination of selection logic and a previous stage output in the form of a PWM signal. Since these outputs only connect to the gates of switches, any minor voltage fluctuation on these lines will not affect the following stage current summation. This configuration allows the interconnect between layers to be reconfigured without signal degradation. When combined with the programmable synaptic weights, this adds a lot of flexibility for an analog neural network without the need to convert analog signals to digital words within the network.

The discussion so far focuses on all of the building blocks for use of a pretrained network in a real-world application. The same signaling methods can also be used as part of a learning process. There are two elements necessary for learning. The first is a method of error distribution and apportionment frequently referred to as backpropagation, and the second is a weight update mechanism. The first step in a learning process is to generate an error signal. The first phase of the forward pass operation proceeds as shown previously to generate a weighted sum of products stored on a capacitor. Instead of using the second phase to discharge the capacitor until it crosses the reference level, the target signal is converted to a PWM signal and the capacitor is only discharged for the duration of the target signal. At this point, if the voltage is above the reference level, a negative error pulse is asserted for the remaining duration of the discharge. If the voltage is below the reference at the end of the target discharge, then a positive error pulse is asserted while the capacitor is recharged to the reference level.

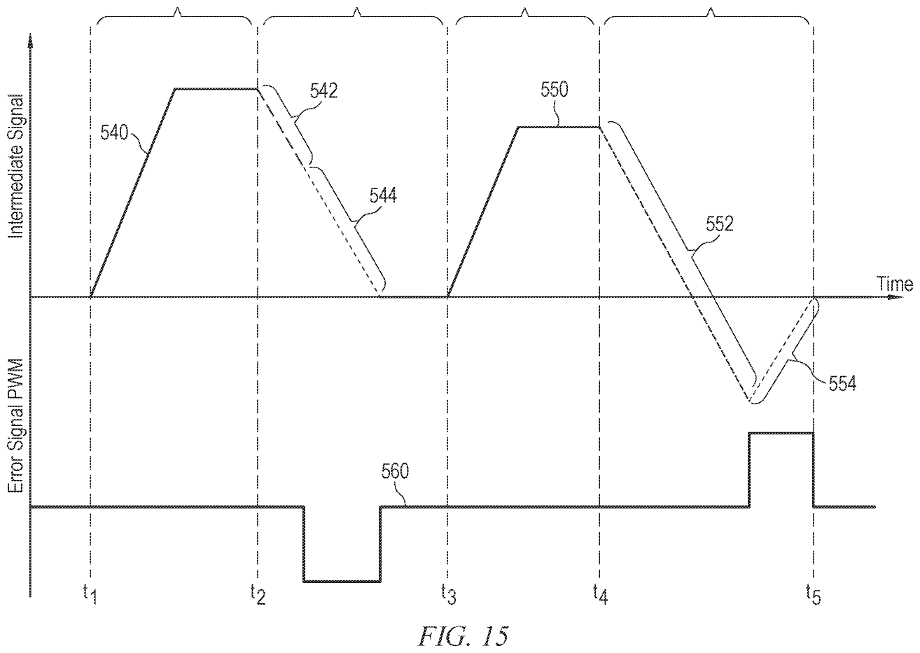

FIG. 15 shows activation signals shown in waveforms 540 and 550 with two different target values. Between times t₁ and t₂ is the forward pass phase with waveform 540 rising to a cap. Between times t₂ and t₃ is the error calculation phase with waveform 540 discharging for the period represented by the target value PWM duration 542, and leaving a residual error signal 544. The error signal 544 is used to generate a pulse in waveform 560. Between times t₃ and t₄ is another forward pass phase with waveform 550 rising to a fully pre-charged level. Between times t₄ and t₅ is the error calculation phase with waveform 550 having target value 552, discharging below the reference level and leaving a residual error signal 554. The error signal 554 generates another pulse in waveform 560.

The output is shown with positive and negative pulses, but could be represented as two positive pulses on respective positive and negative signal lines. As part of the backpropagation process, the error signal needs to be scaled by the derivative of the activation function. For RELU, this can be done by setting a bit if the forward pass exceeds its reference level. If the bit is set, the error pulse is passed unchanged. If the bit is not set, then no error is propagated (or a minimum error level for a leaky RELU function). Since error signals are propagated by the weights between connections, the same weights used in the forward pass can be used in the reverse pass. A separate backward routing bus allows the synapse current summations to route back to the previous layers.

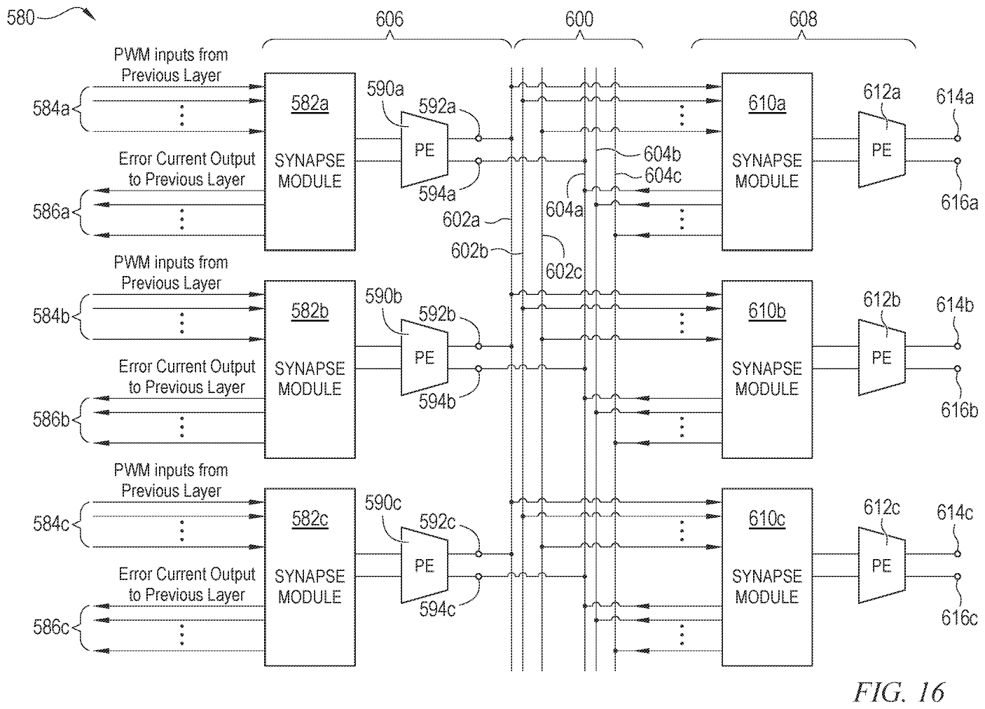

FIG. 16 illustrates ANN 580 with interlayer interconnect structure 600. Synapse module 582a contains synapse network 150 from FIG. 4 or synapse network 250 from FIG. 8. Synapse module 582a receives inputs 584a from a previous layer, and provides error current outputs 586a to the previous layer. Synapse module 582b receives inputs 584b from a previous layer, and provides error current outputs 586b to the previous layer. Synapse module 582c receives inputs 584c from a previous layer, and provides error current outputs 586c to the previous layer. PE 590a receives the output of synapse module 582a and provides pulse out 592a and error in 594a to interconnect structure 600 with nodes 600a-600c and 604a-604c. Likewise, PE 590b receives the output of synapse module 582b and provides pulse out 592b and error in 594b to interconnect structure 600 with nodes 600a-600c and 604a-604c. PE 590c receives the output of synapse module 582c and provides pulse out 592c and error in 594c to interconnect structure 600 with nodes 600a-600c and 604a-604c. PE 590a-590c can be similar to PE 136 and 140. Synapse modules 582a-582c and PE 590a-590c represent layer 606.

In the next layer 608, synapse module 610a contains synapse network 150 from FIG. 4 or synapse network 250 from FIG. 8. Synapse module 610a receives inputs from layer 606 through interconnect structure 600, and provides error current outputs to layer 606 through the interconnect structure. Synapse module 610b receives inputs from layer 606 through interconnect structure 600, and provides error current outputs to layer 606 through the interconnect structure. Synapse module 610c receives inputs from layer 606 through interconnect structure 600, and provides error current outputs to layer 606 through the interconnect structure. PE 612a receives the output of synapse module 610a and provides pulse out 614a and error in 616a to the next layer. Likewise, PE 612b receives the output of synapse module 610b and provides pulse out 614b and error in 616b to the next layer. PE 612c receives the output of synapse module 610c and provides pulse out 614c and error in 616c to the next layer. PE 612a-612c can be similar to PE 136 and 140. Synapse modules 610a-610c and PE 612a-612c represent layer 608. ANN 580 provides forward and reverse signaling paths where the forward bus propagates a PWM timing signal, the reverse bus is used to transfer current from the synapse elements.

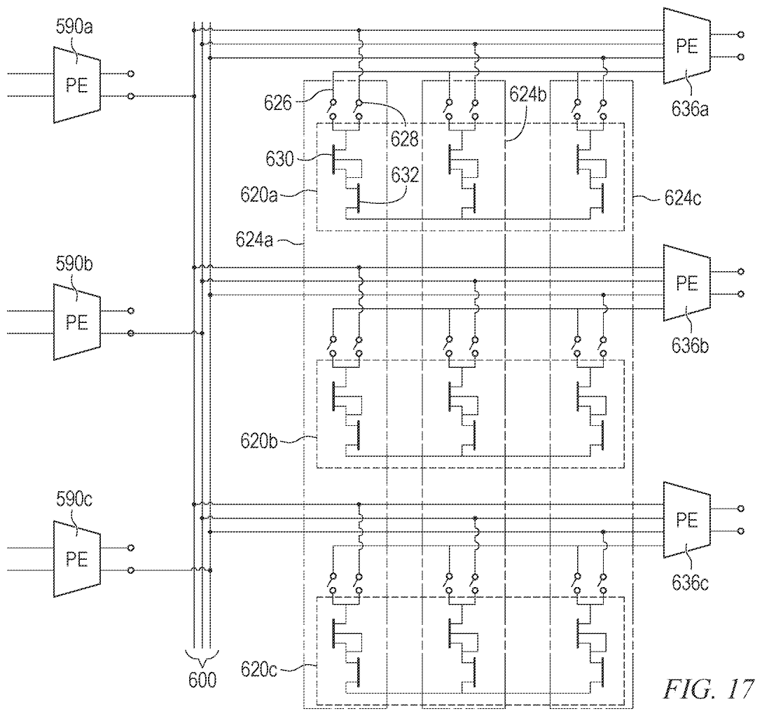

FIG. 17 show further detail of the internal current summations for error backpropagation in the forward and reverse paths from FIG. 16. Boxes 620a, 620b, and 620c illustrate how currents are summed for forward pass, while boxes 624a, 624b, and 624c show how current summations are done for backpropagation between layers. Box 620a, for example, uses cascode transistors 630 and 632 coupled through electrical switches 626 and 628 to PE 636a. Box 620b uses similar cascode transistors coupled through electrical switches to PE 636b. Box 620c uses similar cascode transistors coupled through electrical switches to PE 636c. The Delta inputs on the preceding layer PE elements utilizes the same current ramp method to recreate their respective error pulse. Error pulses are gated with the RELU derivative, as described earlier for each PE element. This method is applied iteratively layer by layer until each unit has an error signal.

In the forward pass operation, a signal is needed for one operation so the discharge phase of the capacitor can be used to control the timing of an output pulse. However, if more than a single operation is needed from a stored value on a charged capacitor, then a second capacitor can be used. The second capacitor will be charged from a reference state and a comparator will detect the point where the second capacitor voltage crosses over the level of the 1st capacitor. The second capacitor can be reset to the reference level and charged up again to generate a second replica pulse. This process can be repeated if more replica pulses are needed.

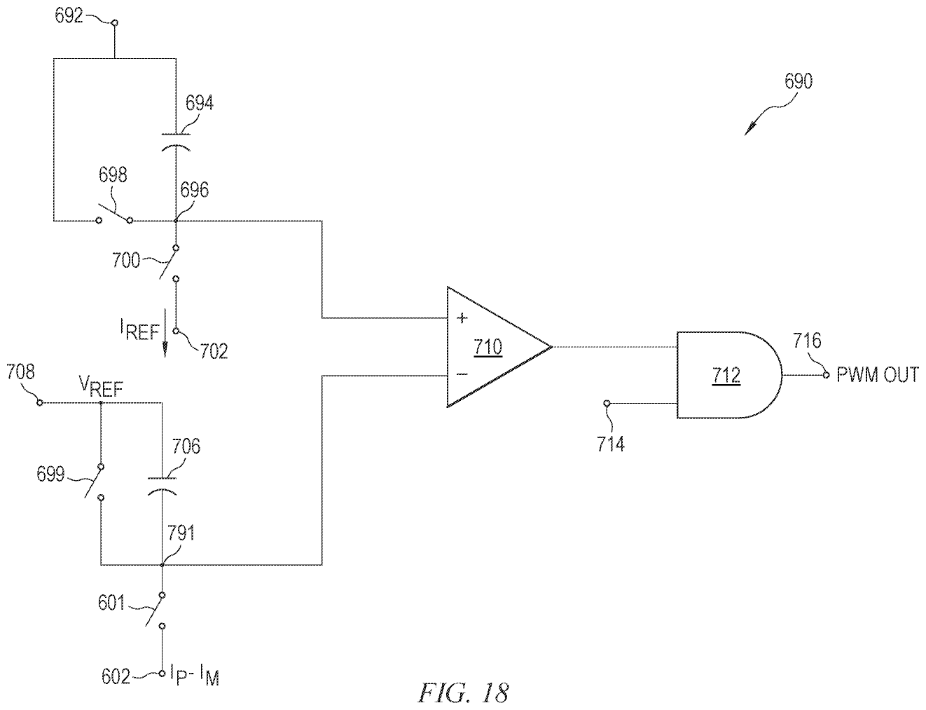

FIG. 18 illustrates a simple implementation of the replica pulse generation. In activation circuit 690, capacitor 706 and capacitor 694 would both be fully discharged and set to a reference voltage that would be connected to nodes 692 and 708. During the pre-charge phase, capacitor 706 would be pre-charged with node 791 now representing the difference in currents I_{P} and I_{M}. If cumulative I_{P} is greater than the cumulative I_{M}, node 791 would be lower than the reference level which is connected to node 708. FIGS. 9a, 9b, and 9c operate in a similar fashion. Now during the activation phase, node 696 will initially be greater than node 791 resulting in a high output from the comparator 710 and logic gate 712 as the activation signal 714 is asserted in this mode. Now switch 700 closes and the voltage on node 696 decreases as I_{REF} discharges capacitor 694. When node 696 crosses below node 791, the comparator 710 transitions low causing the output PWM pulse to go low signaling the end of activation. When a replica pulse is needed, switch 698 and switch 700 toggle, and the activation signal 714 is brought low. Initially switch 700 opens and switch 698 closes discharging the capacitor 694. The start of the replica activation period begins and switch 698 is opened, switch 700 is closed, and the signal on input 714 goes high. The process can be repeated many times, or until leakage on capacitor 706 starts to degrade accuracy.

Capacitor 694 is coupled between reference voltage 692 and node 696. Electrical switch 698 is coupled between node 696 and reference voltage 692. Electrical switch 700 is coupled between node 696 and terminal 702 receiving reference current I_{REF}. Comparator 710 has a non-inverting input coupled to node 696. The inverting input of comparator 710 is coupled to a first terminal of capacitor 706 at node 791. Reference voltage 708 is coupled to a second terminal of capacitor 706. Switch 699 couples the first terminal of capacitor 706 to the reference voltage 708. A second switch 601 couples the first terminal of capacitor 706 to the synapse network providing a difference current of I_{P}−I_{M} at terminal 602, similar to FIGS. 9a, 9b, and 9c. The output of comparator 710 is coupled to a first input of AND gate 712. The output 716 of AND gate 712 is the PWM OUT signal.

Once an error signal is assigned to each PE element, the weight updates are done locally. The weight update follows equations (3) and (4).

Δω*ᵢⱼ=δᵢ×Oⱼ (3)
where: δᵢ is error signal
Oⱼ is the output of the previous state

Δωᵢⱼ=ηΔω*ᵢⱼ+*1−η)Δωᵢⱼ₍ₚᵣₑᵥ₎, (4)
where η is between 0 and 1

Equation (3) shows a given synapse weight update is related to the product of the error signal δᵢ on the one side of the connection, and the output signal Oⱼ on the other side of the connection. Equation (4) is a moving average of equation (3). The coefficients in equation (4) reduce the effect of a single update and move the weight update in the general direction of a group of updates. Both the output Oⱼ and error signal δᵢ are available, but the specific method of weight update will have dependencies on what analog memory structure is chosen.

The weight update operation can be implemented for CTM. The VT's can be shifted in a positive direction by applying a positive gate stress while under a positive Drain to source voltage. Similarly, the VT's can be shifted in the negative direction when applying a negative gate stress with a zero drain to source voltage. As a reference, the GF22 nm standard NMOS devices have a nominal operating limit of about 0.8v gate to source voltage. When gate to source stress is between 1.5v and 2.5v, the charge trapping effect occurs. The amount of VT shift is related to both the duration and amount of electrical field stress. For these devices, drain to source voltages of 1.2v during the positive shift operation appeared to provide optimum performance with respect to data retention. A typical way to program specific analog weights would be to provide a series of short pulses to provide very small shifts in thresholds.

A common analog multiplier based on a gilbert cell configuration would provide a direct product of the two signals. This could be used to control the duration and polarity of weight update pulses to the synaptic weights although it might not be area efficient. Similarly, an update ramp pulse could be generated with the two signals, similar to normal synaptic weight update. One signal (amplitude) would control current magnitude, and the other signal would control integration period. This results in a ramp voltage that is a product of the two signals. The pulse duration resulting from its discharge duration could be used to control the duration and polarity of weight update pulses to the synaptic weights.

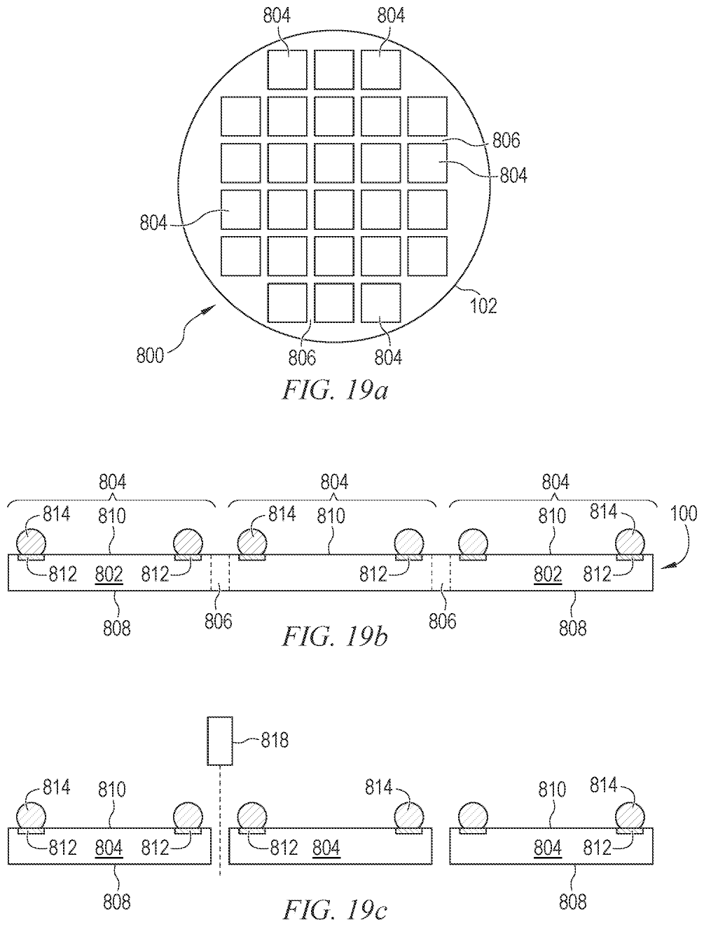

FIG. 19a shows a semiconductor wafer 800 with a base substrate material 802, such as silicon, germanium, aluminum phosphide, aluminum arsenide, gallium arsenide, gallium nitride, indium phosphide, silicon carbide, or other bulk material for structural support. A plurality of semiconductor die or electrical components 804 is formed on wafer 800 separated by a non-active, inter-die wafer area or saw street 806. Saw street 806 provides cutting areas to singulate semiconductor wafer 800 into individual semiconductor die 804. In one embodiment, semiconductor wafer 800 has a width or diameter of 100-450 millimeters (mm).

FIG. 19b shows a cross-sectional view of a portion of semiconductor wafer 800. Each semiconductor die 804 has a back or non-active surface 808 and an active surface 810 containing analog or digital circuits implemented as active devices, passive devices, conductive layers, and dielectric layers formed within the die and electrically interconnected according to the electrical design and function of the die. For example, the circuit may include one or more transistors, diodes, and other circuit elements formed within active surface 810 to implement analog circuits or digital circuits, such as ANN 100 and other features as described herein.

An electrically conductive layer 812 is formed over active surface 810 using physical vapor deposition (PVD), chemical vapor deposition (CVD), electrolytic plating, electroless plating process, or other suitable metal deposition process. Conductive layer 812 can be one or more layers of aluminum (Al), copper (Cu), tin (Sn), nickel (Ni), gold (Au), silver (Ag), or other suitable electrically conductive material. Conductive layer 812 operates as contact pads electrically connected to the circuits on active surface 810.

An electrically conductive bump material is deposited over conductive layer 812 using an evaporation, electrolytic plating, electroless plating, ball drop, or screen printing process. The bump material can be Al, Sn, Ni, Au, Ag, Pb, Bi, Cu, solder, and combinations thereof, with an optional flux solution. For example, the bump material can be eutectic Sn/Pb, high-lead solder, or lead-free solder. The bump material is bonded to conductive layer 812 using a suitable attachment or bonding process. In one embodiment, the bump material is reflowed by heating the material above its melting point to form balls or bumps 814. In one embodiment, bump 814 is formed over an under bump metallization (UBM) having a wetting layer, barrier layer, and adhesive layer. Bump 814 can also be compression bonded or thermocompression bonded to conductive layer 812. Bump 814 represents one type of interconnect structure that can be formed over conductive layer 812. The interconnect structure can also use bond wires, conductive paste, stud bump, micro bump, or other electrical interconnect.

In FIG. 19c, semiconductor wafer 800 is singulated through saw street 806 using a saw blade or laser cutting tool 818 into individual semiconductor die 804. The individual semiconductor die 804 can be inspected and electrically tested for identification of known good die or known good unit (KGD/KGU) post singulation. Semiconductor die 804 are suitable to contain ANN 100 and other features as described herein.

While one or more embodiments of the present invention have been illustrated in detail, the skilled artisan will appreciate that modifications and adaptations to those embodiments may be made without departing from the scope of the present invention as set forth in the following claims.

What is claimed:

1. A neural network, comprising:
a synapse module including a plurality of synapses;
a steering circuit coupled to an output of the synapse module; and
a plurality of processing elements coupled to an output of the steering circuit, wherein each of the processing elements share the synapses of the synapse module through the steering circuit.

2. The neural network of claim 1, wherein a first synapse of the plurality of synapses includes:
a first transistor conducting a selectable current;
a second transistor coupled to a node and conducting the selectable current;
a first switching circuit coupled between the node and a first output of the first synapse;
a second switching circuit coupled between the node and a second output of the first synapse; and
a logic circuit controlling the first switching circuit and second switching circuit.

3. The neural network of claim 2, wherein the selectable current is set by a threshold of the first transistor.

4. The neural network of claim 1, wherein a first processing element of the plurality of processing elements receives a current from a first output of a first synapse of the plurality of synapses.

5. The neural network of claim 4, wherein the first processing element includes a capacitor receiving the current.

6. The neural network of claim 4, further including a polarity inversion circuit coupled for receiving the current and reversing flow direction of the current.

7. A method of making a neural network, comprising:
providing a synapse module including a plurality of synapses; and
providing a plurality of processing elements each sharing the synapses of the synapse module.

8. The method of claim 7, further including providing a steering circuit coupled to an output of the synapse module and an input of the processing elements.

9. The method of claim 8, wherein each of the processing elements can reuse the synapses of the synapse module through the steering circuit in a time interleaved operation.

10. The method of claim 7, wherein activation outputs of the plurality of processing elements are selectively digitally coupled to a subsequent layer of inputs of the synapse module.

11. The method of claim 7, wherein a first synapse of the plurality of synapses includes:
providing a first transistor conducting a selectable current;
providing a second transistor coupled to a node and conducting the selectable current;
providing a first switching circuit coupled between the node and a first output of the first synapse;
providing a second switching circuit coupled between the node and a second output of the first synapse; and
providing a logic circuit controlling the first switching circuit and second switching circuit.

12. The method of claim 11, wherein the selectable current is set by a threshold of the first transistor.

13. The method of claim 7, wherein a first processing element of the plurality of processing elements receives a current from a first output of a first synapse of the plurality of synapses.

14. The method of claim 13, wherein the first processing element of the plurality of processing elements includes providing a capacitor receiving the current.

15. The method of claim 13, further including providing a polarity inversion circuit coupled for receiving the current and reversing flow direction of the current.

16. A semiconductor device, comprising:
a synapse module including a plurality of synapses; and
a plurality of processing elements each sharing the synapses of the synapse module.

17. The semiconductor device of claim 16, further including a steering circuit coupled to an output of the synapse module and an input of the processing elements.

18. The semiconductor device of claim 16, wherein a first synapse of the plurality of synapses includes:
a first transistor conducting a selectable current;
a second transistor coupled to a node and conducting the selectable current;
a first switching circuit coupled between the node and a first output of the first synapse;
a second switching circuit coupled between the node and a second output of the first synapse; and
a logic circuit controlling the first switching circuit and second switching circuit.

19. The semiconductor device of claim 18, wherein the selectable current is set by a threshold of the first transistor.

20. The semiconductor device of claim 16, wherein a first processing element of the plurality of processing elements receives a current from a first output of a first synapse of the plurality of synapses.

21. The semiconductor device of claim 20, wherein the first processing element includes a capacitor receiving the current.

22. The semiconductor device of claim 20, further including a polarity inversion circuit coupled for receiving the current and reversing flow direction of the current.
